(19) United States
(12) Patent Application Publication
(10) Pub. No.: US 2012/0160427 A1
(43) Pub. Date: Jun. 28, 2012

(54) GUIDE RAIL DEVICE OF VEHICLE REAR WINDOW BLIND ASSEMBLY

(75) Inventor: Paul Lin, Tainan City (TW)

(73) Assignee: MACAUTO INDUSTRIAL CO., LTD., Tainan City (TW)

(21) Appl. No.: 13/297,880

(22) Filed: Nov. 16, 2011

(30) Foreign Application Priority Data
Dec. 24, 2010 (TW) 099225046

(51) Int. Cl. E06B 9/17

(52) U.S. Cl. 160/266

(57) ABSTRACT

A guide rail device includes a guide rail adapted to be disposed in an inner surface of a C-column and having a rail body and a connecting part disposed at a bottom of the rail body. The connecting part has two symmetrical projecting studs respectively projecting frontward and rearward. A connecting seat is connected to the bottom of the rail body, and has a seat body adapted to be disposed at one end of a winding shaft, and two symmetrical engaging portions provided on the seat body. The projecting studs are respectively inserted into the engaging portions in a top-to-bottom direction.

### CROSS-REFERENCE TO RELATED APPLICATION

This application claims priority of Taiwanese Patent Application No. 099225046, filed on Dec. 24, 2010.

### BACKGROUND OF THE INVENTION

1. Field of the Invention

This invention relates to a guide rail device of a vehicle rear window blind assembly, and more particularly to a guide rail device of a vehicle rear window blind assembly that can be easily and quickly assembled.

2. Description of the Related Art

Referring to FIG. 1, a conventional vehicle rear window blind assembly 1 generally includes a winding shaft 11 disposed rotatably below a rear window shelf 3, two fixed seats 12 disposed respectively on two opposite ends of the winding shaft 11, two guide rails 13 respectively disposed in inner surfaces of two confronting C-columns 5, a movable rod 14, a blind 15, two drive rods 16, and a power unit 17. Each guide rail 13 extends from a top edge of a vehicle rear window (not shown) to a position below the rear window shelf 3, and is connected to a respective one of the fixed seats 12. The movable rod 14 has two opposite ends connected respectively to the guide rails 13, and is movable upward and downward between the rear window shelf 3 and the top edge of the vehicle rear window. The blind 15 has a topside connected to the movable rod 14, and a bottom side extending beyond the rear window shelf 3 to connect with the winding shaft 11. Each drive rod 16 extends through the respective fixed seat 12, and is slidable on the respective guide rail 13 to move the movable rod 14. The power unit 17 drives the two drive rods 16 to slide upward and downward.

However, during assembly of the aforesaid guide rails 13, an insert portion 131 of each guide rail 13 is first inserted fixedly into an insert portion 121 of the respective fixed seat 12, after which each guide rail 13 is disposed in amounting groove of the inner surface of the respective C-column 5.

For manufacturers, the aforesaid guide rails 13 must be easily and quickly assembled and positioned to conform to their requirements. The applicant makes a structural improvement on a connection between the guide rails and the winding shaft of the vehicle rear window blind assembly so that the connection between the same is easy, quick and stable.

### SUMMARY OF THE INVENTION

Therefore, the object of the present invention is to provide a guide rail device of a vehicle rear window blind assembly that can be easily and quickly assembled and positioned.

According to this invention, a guide rail device of a vehicle rear window blind assembly comprises a guide rail and a connecting seat. The guide rail is adapted to be disposed in an inner surface of a C-column, and has a rail body and a connecting part disposed at a bottom of the rail body. The connecting part has two symmetrical projecting studs respectively projecting frontward and rearward. The connecting seat is connected to the bottom of the rail body, and has a seat body adapted to be disposed at one end of a winding shaft, and two symmetrical engaging portions provided on the seat body. The projecting studs are respectively inserted into the engaging portions in a top-to-bottom direction.

The advantage of the present invention resides in that through the configuration of the two projecting studs that are respectively inserted into the engaging portions in a top-to-bottom direction, the overall structure can achieve the effect of quick and easy assembling and positioning.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a structural view of a conventional vehicle rear window blind assembly;

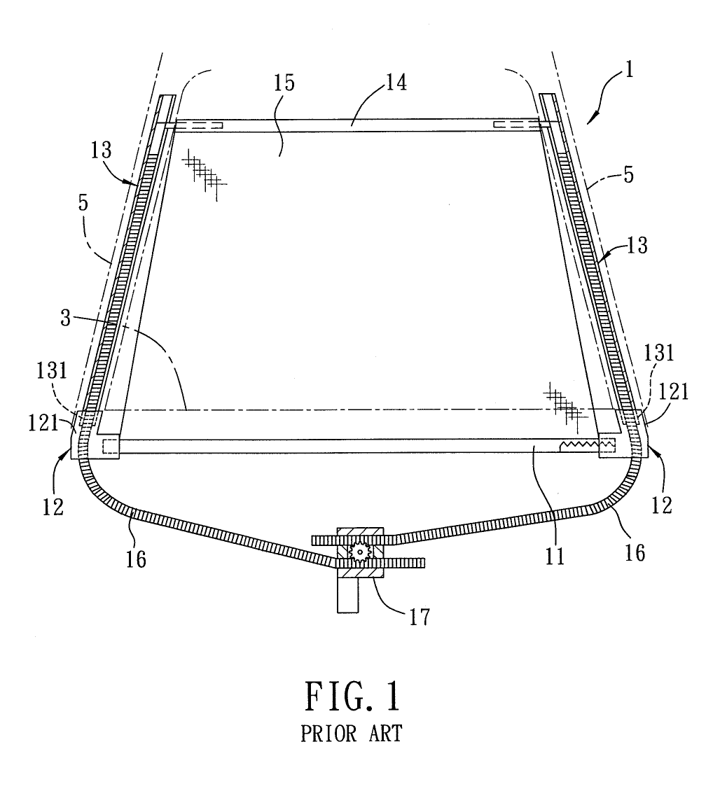

FIG. 2 is an exploded perspective view of a guide rail device of a vehicle rear window blind assembly according to the first preferred embodiment of this invention;

FIG. 3 is a fragmentary sectional view of the first preferred embodiment;

FIG. 4 is an exploded perspective view of a guide rail device of a vehicle rear window blind assembly according to the second preferred embodiment of this invention; and

FIG. 5 is a fragmentary sectional view of the second preferred embodiment.

### DETAILED DESCRIPTION OF THE PREFERRED EMBODIMENTS

The above-mentioned and other technical contents, features, and effects of this invention will be clearly presented from the following detailed description of two preferred embodiments in coordination with the reference drawings.

Before this invention is described in greater detail, it should be noted that, in the following description, similar elements are designated by the same reference numerals.

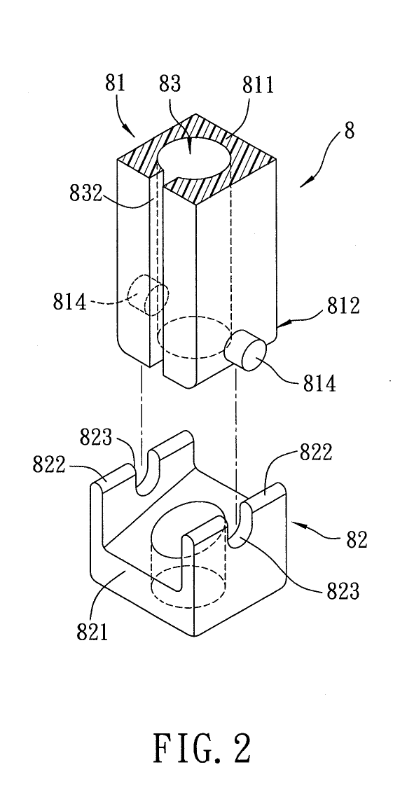

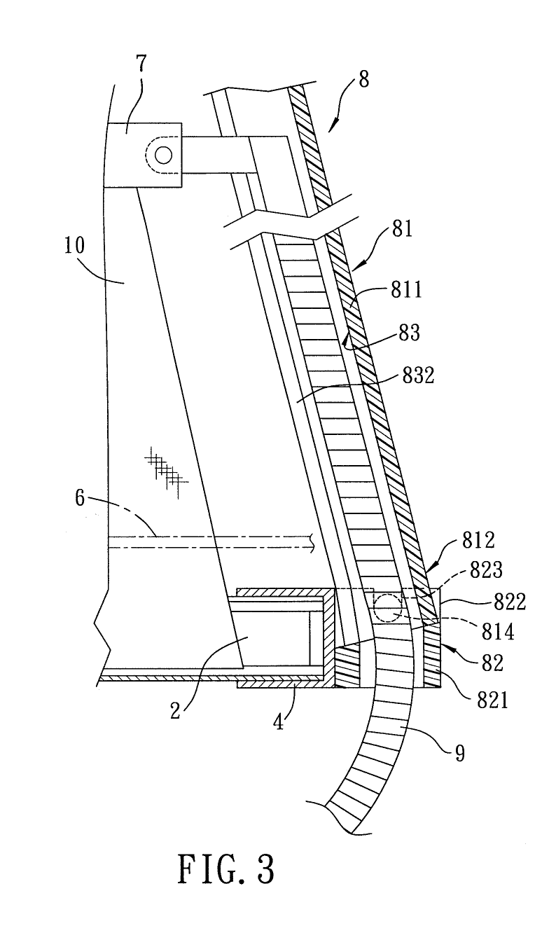

FIGS. 2 and 3 illustrate a guide rail device 8 of a vehicle rear window blind assembly according to the first preferred embodiment of this invention. The vehicle rear window blind assembly includes a winding shaft 2 disposed rotatably below a rear window shelf 6, two fixed seats 4 (only one is shown) disposed respectively on two opposite ends of the winding shaft 2, two guide rail devices 8 (only one is shown) of the present invention respectively disposed in inner surfaces of two confronting C-columns (not shown), a movable rod 7, a blind 10, two drive rods 9 (only one is shown), and a power unit (not shown). Each guide rail device 8 extends from a top edge of a vehicle rear window (not shown) to a position below the rear window shelf 6, and is connected to a respective one of the fixed seats 4. The movable rod 7 has two opposite ends connected respectively to the guide rail devices 8, and is movable upward and downward between the rear window shelf 6 and the top edge of the vehicle rear window. The blind 10 has a top side connected to the movable rod 7, and a bottom side extending beyond the rear window shelf 6 to connect with the winding shaft 2. Each drive rod 9 is slidable on the respective guide rail device 8 to move the movable rod 7. The power unit drives the two drive rods 9 to slide upward and downward. Since the drawings only illustrate one of the guide rail devices 8 of the vehicle rear window blind assembly of the present invention and the partial structures of the related components, only one of the guide rail devices 8 and the partial structures of the related components will be described hereinafter.

The guide rail device 8 comprises a guide rail 81 and a connecting seat 82. The guide rail 81 is disposed in the inner surface of one of the C-columns, and extends from the top edge of the vehicle rear window to the position below the rear window shelf 6. The guide rail 81 has a rail body 811 located above the rear window shelf 6, and a connecting part 812 connected integrally to a bottom of the rail body 811 and located below the rear window shelf 6. The connecting part 812 has two symmetrical projecting studs 814 respectively projecting from front and rear faces of the connecting part 812.

The connecting seat 82 is disposed below the rear window shelf 6, and is connected to the bottom of the rail body 811. The connecting seat 82 has a seat body 821 disposed at one end of the winding shaft 2, and two symmetrical engaging portions 822 provided on the seat body 821. The seat body 821 has a top face abutting against a bottom face of the connecting part 812. In this embodiment, the engaging portions 822 are formed as flange plates. The engaging portions or flange plates 822 are spaced apart and confront each other, are disposed on front and rear sides of a top face of the seat body 821, and respectively abut against the front and rear faces of the connecting part 812. That is, the connecting part 812 is embraced by the connecting seat 82. Each flange plate 822 has a downwardly extending recess 823. The recesses 823 of the flange plates 822 receive and embrace the respective projecting studs 814. As such, the rail body 81 can be adjusted relative to the connecting seat 82. It should be noted that the projecting studs 814 are respectively inserted into the recesses 823 of the engaging portions 822 in a top-to-bottom direction.

Further, the rail body 811 and the seat body 821 cooperatively define a channel 83. The drive rod 9 is inserted into and is slidable upward and downward in the channel 83. The rail body 811 has a slit opening 832 extending along the length thereof, communicating with the channel 83, and facing the blind 10. The movable rod 7 has one end inserted into the channel 83 via the slit opening 832 to connect with the drive rod 9.

During assembly of the guide rail device 8, the two projecting studs 814 of the guide rail 81 are simply engaged to the recesses 823 in the respective engaging portions 822 of the connecting seat 82 to thereby connect stably the guide rail 81 and the connecting seat 82, after which the guide rail 81 is installed and fixed to the inner surface of the C-column. Thus, assembly and positioning of the guide rail device 8 of the present invention can be accomplished in a quick and simple manner.

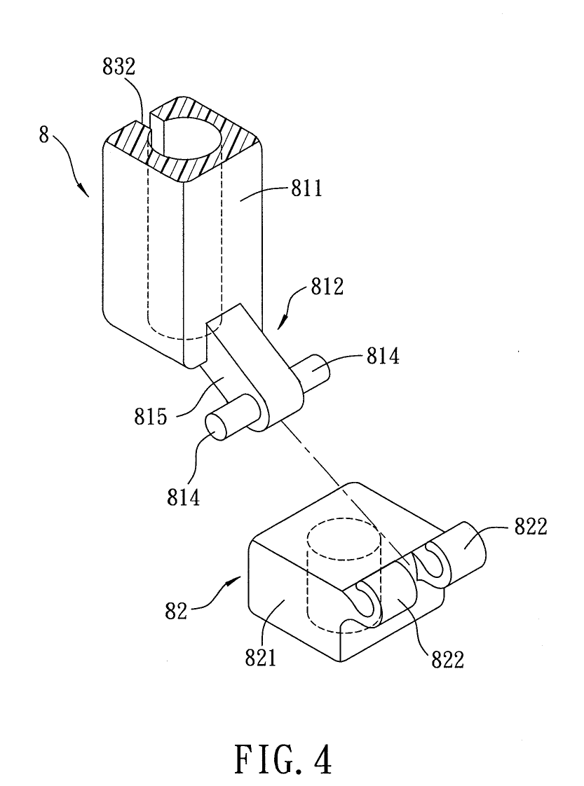

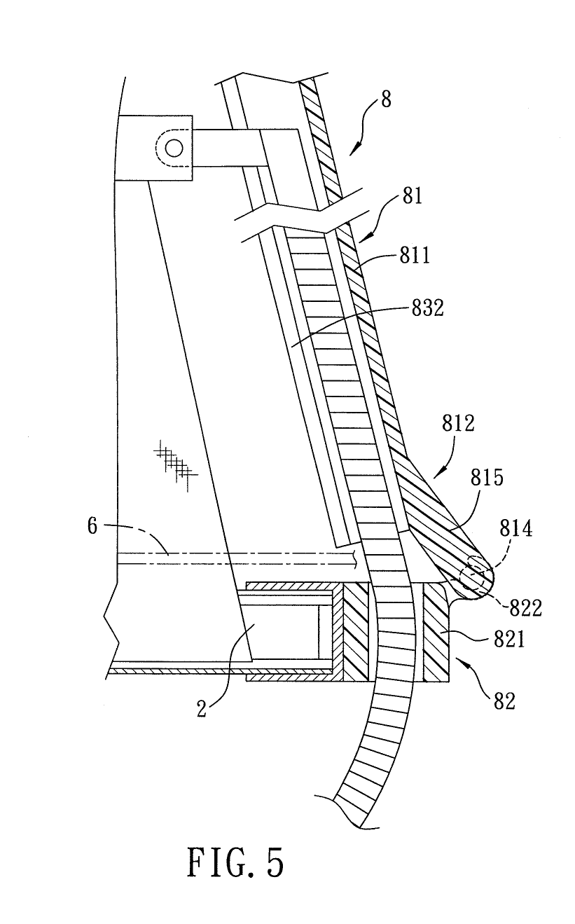

Referring to FIGS. 4 and 5, a vehicle rear window blind assembly according to the second preferred embodiment of this invention is shown to be similar to the first preferred embodiment. However, in this embodiment, the connecting part 812 further has a link rod 815 that is connected integrally to and that extends downwardly and inclinedly from the bottom of the rail body 811 and that is opposite to the slit, opening 832. The projecting studs 814 respectively project from front and rear faces of a bottom portion of the link rod 815. Further, the seat body 821 of the connecting seat 82 is spaced apart from the rail body 811. The two engaging portions 822 are configured as hooks that are spaced apart in a front-rear direction and that are disposed on a top portion of the seat body 821 distally from the winding shaft 2.

During assembly of the guide rail device 8, similarly, the two projecting studs 814 of the guide rail 81 are simply engaged to the respective engaging portions 822 of the connecting seat 82 to thereby stably connect the guide rail 81 and the connecting seat 82, after which the guide rail 81 is installed and fixed to the inner surface of the C-column. Thus, the assembly and positioning of the guide rail device 8 of this embodiment can be similarly accomplished in a quick and simple manner.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A guide rail device of a vehicle rear window blind assembly, comprising:
a guide rail adapted to be disposed in an inner surface of a C-column and having a rail body and a connecting part disposed at a bottom of said rail body, said connecting part having two symmetrical projecting studs respectively projecting frontward and rearward; and
a connecting seat connected to said bottom of said rail body and having a seat body adapted to be disposed at one end of a winding shaft, and two symmetrical engaging portions provided on said seat body, said projecting studs being respectively inserted into said engaging portions in a top-to-bottom direction.

2. The guide rail device of claim 1, wherein said rail body and said seat body cooperatively define a channel.

3. The guide rail device of claim 2, wherein said connecting part is embraced by said connecting seat, said projecting studs projecting respectively from front and rear faces of said connecting part, said engaging portions of said connecting seat being formed as flange plates that are spaced apart and confront each other, that are disposed on front and rear sides of a top face of said seat body, and that respectively abut against said front and rear faces of said connecting part, each of said flange plates having a downwardly extending recess to receive a respective one of said projecting studs.

4. The guide rail device of claim 2, wherein said rail body has a slit opening communicating with said channel, said connecting part further having a link rod that is connected to and that extends downwardly and inclinedly from said bottom of said rail body, and that is opposite to said slit opening, said projecting studs respectively projecting from front and rear faces of said link rod, said engaging portions of said connecting seat being configured as hooks that are disposed on said seat body distally from the winding shaft, and spaced apart in a front-rear direction.
